(19) United States
(12) Patent Application Publication
(10) Pub. No.: US 2016/0157416 A1
(43) Pub. Date: Jun. 9, 2016

(54) SEED METER

(71) Applicant: Deere & Company, Moline, IL (US)

(72) Inventor: LEE E. ZUMDOME, BETTENDORF, IA (US)

(21) Appl. No.: 15/043,728

(22) Filed: Feb. 15, 2016

Related U.S. Application Data
(63) Continuation-in-part of application No. 14/170,403, filed on Jan. 31, 2014, now Pat. No. 9,313,943.

(51) Int. Cl. A01C 7/04

(52) U.S. Cl. CPC A01C 7/046

(57) ABSTRACT

A seed meter is disclosed as having resilient tines for eliminating multiple seeds from being disposed for planting. As the seeds are displaced along a seed path, the resilient tines contacts the additional seeds with a force so as to dislodge additional seeds while not dislodging seeds wherein individual seeds are present. This helps in planting the seeds individually and sequentially.

### CROSS REFERENCE TO RELATED APPLICATIONS

This application is a Continuation-in-part of US2015/0216115 A1, filed Jan. 31, 2014 as application Ser. No. 14/170,403.

### FIELD

The invention concerns an agricultural machine for sowing individual seeds.

### BACKGROUND

Seed meters facilitate mechanized sowing of seeds with increased efficiency. One type of seed meter operates using differential air pressure, either by creating vacuum or maintaining positive pressure. The air pressure difference is cause seeds to adhere to a metering device. The metering device takes the seeds from a seed pool of a seed meter and sequentially discharges individual seeds for sowing on the field.

Other types of seed meters are disclosed in U.S. Pat. No. 6,273,010 (a finger pick-up meter); U.S. Pat. No. 5,720,233 (a radial bean meter); and U.S. Pat. No. 6,237,514 (a belt meter). In these seed meters and all the other types of seed meters, it is required to have seeds to be singled out so that multiple seeds being planted together can be avoided. This is because it is desirable to plant individual seed at a time for ensuring requisite nutrient supply and proper growth of the seed. Thus, it may be useful to provide a seed double eliminator for effectively eliminating multiple seeds without damaging the seeds.

### SUMMARY

A seed meter is disclosed for removing multiple seeds by resilient tines and causing individual and sequential seeds for being planted.

The resilient tines are disposed on the seed meter so as to extend into a seed path on a metering device of the seed meter carrying seeds. As the metering device moves or rotates with the seeds, the resilient tines contact the seeds with a force, sufficient for dislodging multiple seeds. The resilient tines are configured such that, in case of individual seed, the resilient tines do not strike the individual seeds with sufficient force for dislodging the individual seed. This ensures that individual and sequential movement of seeds for planting.

Various other embodiments are contemplated, within the scope of the discussion herein.

### BRIEF DESCRIPTION OF THE DRAWINGS

The detailed description of the drawings refers to the accompanying figures in which:

FIG. 1 illustrates a perspective view of a seed meter with cover open indicating a metering device;

FIG. 2 illustrates a perspective view of the metering device of the seed meter of FIG. 1;

FIG. 3 illustrates a cross-sectional view of the metering device of the seed meter of FIG. 2;

FIG. 4 illustrates a perspective view of the seed meter of FIG. 1 illustrating the internal components of the seed meter, including resilient tines; and

FIG. 5 to FIG. 6 illustrates operation of resilient tines for eliminating multiple seeds from the metering device.

Like reference symbols in the various drawings indicate like elements.

### DETAILED DESCRIPTION OF THE DRAWINGS

The following describes one or more exemplary embodiments of the disclosed resilient tines, as shown in the accompanying figures of the drawings described briefly above. Various modifications to the example embodiments may be contemplated by one of skill in the art.

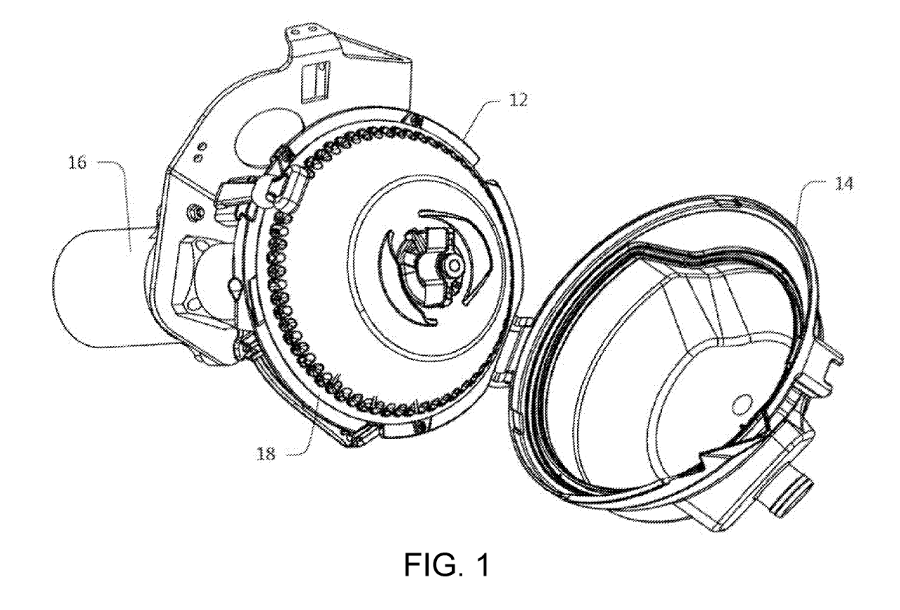

Agricultural seeding machines include seed meters 10, illustrated in FIG. 1. The seed meter 10 may include housing 12 and cover 14. Housing 12 and the cover 14 is coupled to one another by complementary hinge features on housing 12 and cover 14, respectively. The seed meter may be operated by motor via a drive spindle 16 coupled to the housing 12. Alternatively, mechanical or hydraulic drives may also be used for operating the motor. The seed meter 10 includes a metering device 18. It is understood that it may be useful to eliminate seeds to multiple seeds from being planted together.

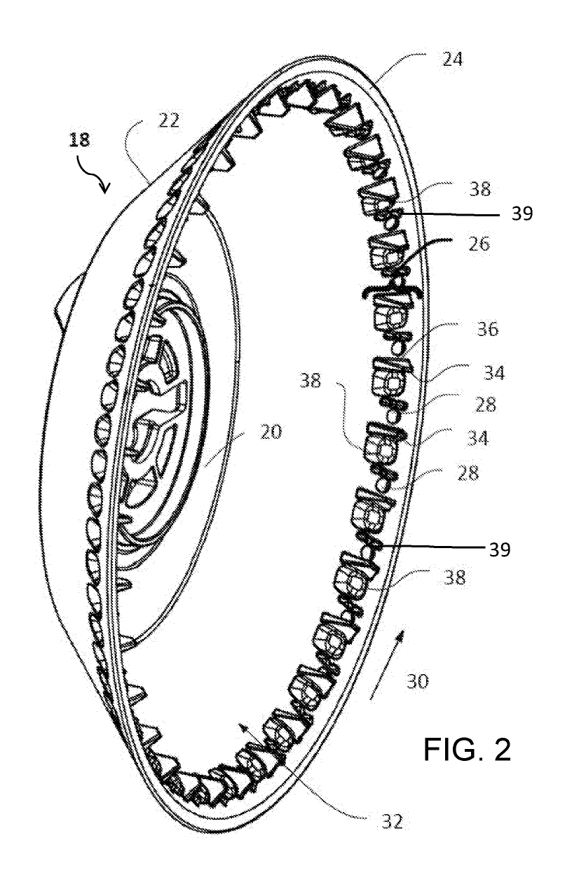

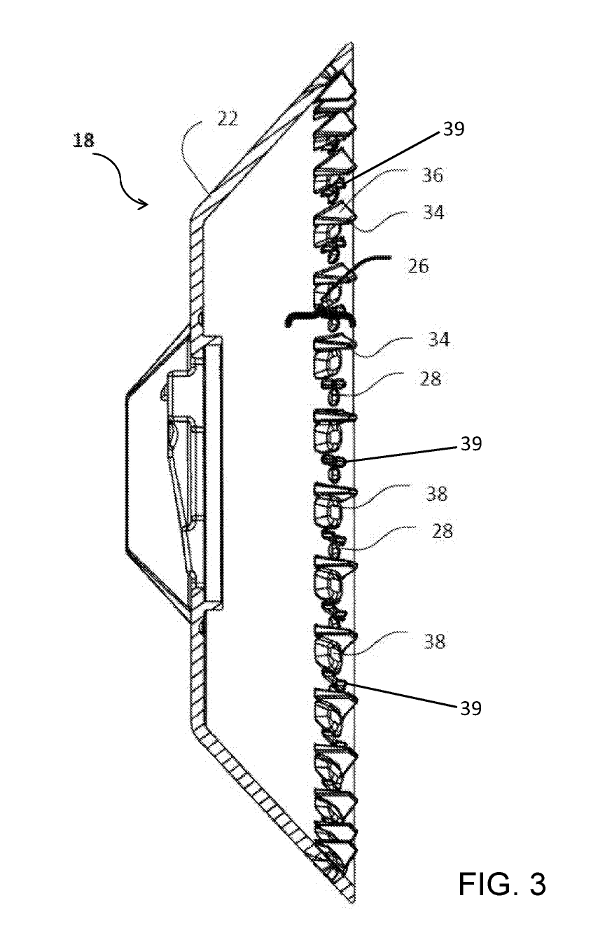

FIG. 2 and FIG. 3 illustrate the metering device 18 of seed meter 10. The metering device 18 (as shown in FIG. 2 and FIG. 3) may be a concave bowl-shaped body. The bowl-shaped body may have base portion 20 from which side wall 22 extends. Side wall 22 may terminate in outer edge 24. Adjacent to the outer edge 24, the side wall 22 may include a rim portion 26, as indicated by bracket in FIG. 2 and FIG. 3, which may extend radially outwardly and axially toward outer edge 24. Within the rim portion 26, an annular array of cavities 28 may extend between the inner and outer surfaces of side wall 22.

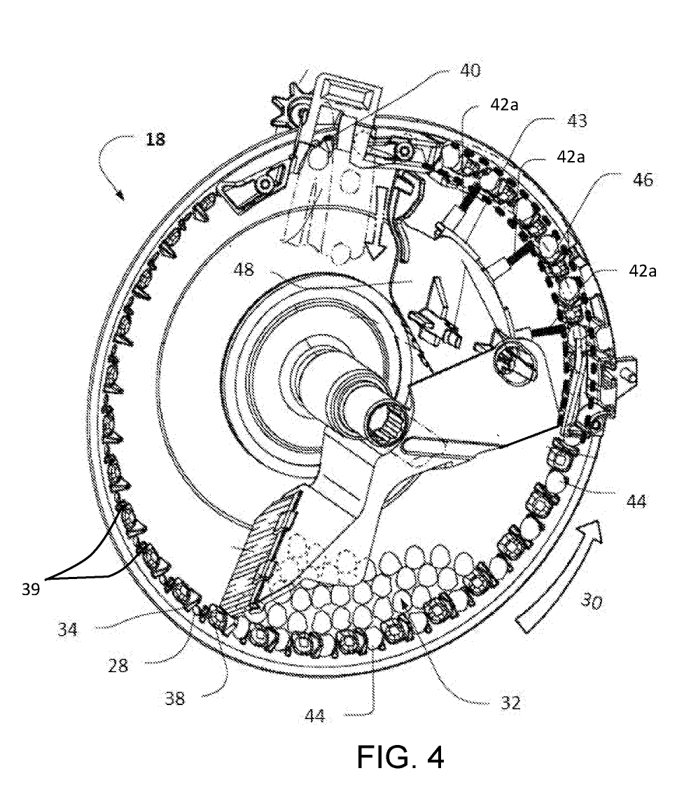

The metering device 18 may be mounted in meter housing 12 for rotation in the direction of arrow 30 indicated in FIG. 2. In assembled configuration of the metering device 18 and the housing 12, a seed pool 32, illustrated in FIG. 4, is defined. In operation, as the metering device 28 rotates, seeds from the seed pool 32, located at a bottom portion of metering device 18, may adhere to cavities 28 on the inner surface of side wall 22 and thereby be sequentially carried upward to release position 40 at an upper portion of metering device 18.

A series of raised features or projections, such as, structures 34, may extend from the inner surface of side wall 22. In certain embodiments, one structure may be located behind each aperture 28, with respect to direction of rotation 30. Each structure 34 may accordingly form a confronting surface 36 behind the associated aperture 28 in the direction of rotation 30 to push a seed adhered to the aperture into a delivery system (not shown) for delivering the seed from the seed meter 10 to the ground for planting. In certain embodiments, metering device 18, as installed in housing 12, may be oriented at an angle from vertical. Additionally, in certain embodiments, the metering device 18 may include raised structures 38 and or 39 between adjacent structures 34.

With the rotation of the metering device 18, in the direction of rotation 30, seeds 44 are caused to adhere to the cavities 28 by virtue of vacuum applied on the outer surface of side wall 22, as the cavities 28 travel through the seed pool 32. However, multiple seeds may also adhere to the cavities 28. It becomes necessary to remove multiple seeds from the cavities 28 before the seeds are dispensed to the delivery system at a release position 40. This is because the presence of multiple seeds may detrimentally affect the efficiency and efficacy of the planting operation. Accordingly, there are systems implemented to remove multiple seeds, for example, using brushes having plurality of bristles. However, over time the bristles tend to spread out with respect to the tuft of the bristles. This reduces the effective elimination of multiple seeds and thereby reduces effectiveness of the seed meter 10.

Accordingly, referring to FIG. 4 to FIG. 6, a plurality of resilient tines 42 is used with the metering device 18 to eliminate multiple seeds and ensure individual seed to be moved to the delivery system from each of the cavities 28. The service life of the resilient tines 42 is much longer than the brushes. The resilient tines 42 are made of Polyurethane, nylon or rubberized material, for example polyester-based thermoplastic polyurethane having shore hardness of 88 A and flexural modulus of 6700 psi at 73 F. The resilient tines 42 have a predefined profile, such as, an arcuate profile, flat profile, cylindrical profile or polygonal profile. Further, the resilient tines 42 have a predefined cross-section, such as, circular, polygonal or oval. The resilient tines 42 are radially spaced apart from adjacent resilient tines 42. It is essential that the resilient tines 42 are efficient to eliminate multiples seeds from the cavities 28 under wide range of vacuum applied. It is also necessary to ensure that the resilient tines 42 are efficient in eliminating skips in the cavities 28. This means that when the vacuum is low, the resilient tines 42 should operate such that individual seeds in the cavities 28 are not dislodged. Thus, the resilient tines 42 are configured to maintain the Coefficient of variation (COV) such that the seed spacing is accurately maintained for each crop type.

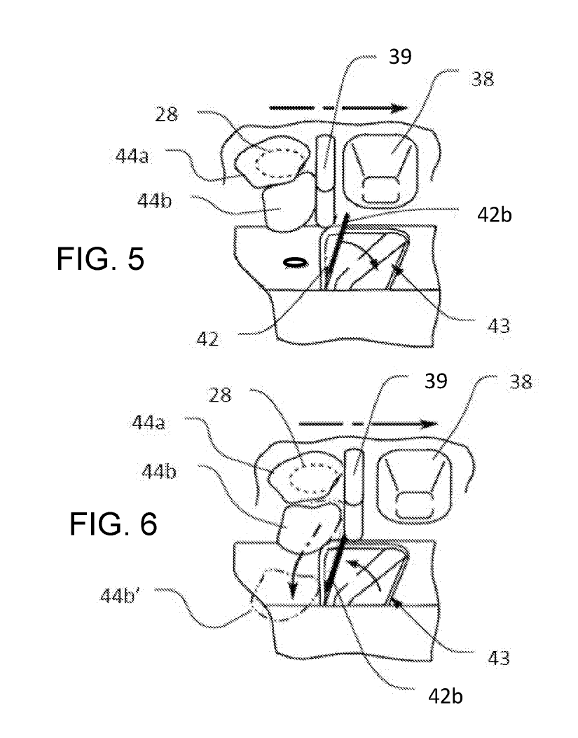

The metering device 18 carries seeds 44 from the seed pool 32 along a seed path 46, as illustrated in FIG. 4. As illustrated, the seed path 46 is circular. However, seed meters with different types of metering devices, e.g. a metering belt, may have a seed path with a combination of straight and arcuate segments. The seeds 44 are transferred to the release position 40 for being discharged to the delivery system. The resilient tines, referred to collectively as 42, are positioned before the release position 40. The resilient tines 42 comprise inner tines 42a, indicated in FIG. 4, and outer tines 42b, indicated in FIG. 5 and FIG. 6. The resilient tines 42 in operative configuration extend towards the seed path 46. The resilient tines 42 are mounted with respect to the housing 12 by various known attachment techniques. The resilient tines 42a are mounted on a sliding adjustable holder by mounting fixture 48 for adjusting the distance through which the resilient tines 42a extend towards the seed path 46. The resilient tines 42a are configured to extend radially to the radially inner side of the seed path 46. The mounting fixture 48 is radially adjustable to move the tines 42a radially outwardly or inwardly to vary the aggressiveness of the double eliminator function.

The resilient tines 42b which are positioned radially outward of the seed path 46 are provided with predefined clearances via pockets 43 in the housing 12 to facilitate movement of the resilient tines 42 without interference. The resilient tines 42 have a fixed end and an operative free end. The free end of all the resilient tines 42 may extend into the seed path 46 by the same distance. Alternatively, the resilient tines 42 may extend into the seed path 46 by the variable distances. The free end of the resilient tines 42 are configured so as to contact multiple seeds 44 carried between the structures 34, with sufficient force so as to dislodge the multiple seeds from the seed path 46. However, the free end of the resilient tines 42 are configured not to contact the individual seeds 44 or to contact the individual seeds 44 with a force insufficient to dislodge them from the seed path 46. Thus, the resilient tines 42 are configured not only to eliminate multiple seeds but also to avoid skips.

FIG. 5 and FIG. 6 illustrate operation of the resilient tines 42b in eliminating the multiple seeds from between the structures on the metering device. Considering the seeds 44a and 44b carried by the metering device 18 following a structure 39. As the structure 39 reaches the resilient tine 42 (illustrated in FIG. 5), it tends to deflect the resilient tine 42b out of its way and away from seed path 46. In certain embodiments, this may deflect resilient tine 42b fully (or partially) within pocket 43. As structure 39 passes the resilient tine 42b (as in FIG. 6), the resilient tine 42b springs back out of pocket 43 to contact seed 44b of the depicted multiple seeds. This contact may tend to dislodge seed 44b, while leaving seed 44a in its seat at aperture 28. The dislodged seed 44b′ falls back to the seed pool 32. As the seed 44a may be located close enough to the wall of metering device 18, the resilient tines 42 may not contact seed 44a (or may contact seed 44a with a force that is insufficient to dislodge seed 44a). Thus, the resilient tines 42 ensure delivery of the seeds 44 individually and sequentially to the delivery system. The resilient tines 42a, positioned radially inside of the seed path 46, engage the seeds 44 from the opposite side of the tines 42b and operate in the same fashion as the tines 42b described above. The resilient tines 42 may also be used with metering devices that do not include the raised structures 34, 38 or 39 to remove excess seeds from the metering device.

Use of the resilient tines 42 in place of brushes with bristles has produced significant improvement in set-up and operation of the meter. Testing has shown a significant increase in the range of suitable vacuum pressures to achieve singulation accuracy between 99 and 101 percent. For example, when testing the seed meter using Mycogen 2A509a seed corn, the vacuum range with bristles to achieve 99 to 101 percent singulation was 7.3 to 8.3 inches of water. This range of only 1 inch of vacuum is less than the typical vacuum variation between rows on a planter. Thus, at a given vacuum setting within this range, some meters would have a vacuum outside of this range and thus lower singulation accuracy. With the resilient tines 42, however, the acceptable range of vacuum increased to nearly 7 inches of water, from 15.4 to 22.1 inches of water. This range is large enough that all row units on the planter can be within this range producing a singulation accuracy of 99 to 101 percent across the planter.

While the resilient tines 42 are shown in the context of a vacuum seed meter, the resilient tines 42 can be used in other types of meters such as the finger pick-up meter, the radial bean meter and the belt meter, mentioned above, etc.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. Explicitly referenced embodiments herein were chosen and described in order to best explain the principles of the disclosure and their practical application, and to enable others of ordinary skill in the art to understand the disclosure and recognize many alternatives, modifications, and variations on the described example(s).

Accordingly, various embodiments and implementations other than those explicitly described are within the scope of the following claims.

What is claimed is:

1. A seed meter for singulating seed from a seed pool and sequentially dispensing individual seeds at a discharge location, the seed meter comprising:
a housing;
a seed metering device movable within said housing, said seed metering device defining cavities for collecting seeds therein and carrying seeds from the seed pool along a defined seed path to the discharge location as the seed metering device moves within said housing; and
a plurality of elongated resilient tines having a proximal end fixed to the housing and an operative distal end, said operative distal end of said resilient tines configured to contact the seeds in said cavities to remove excess seed from said cavities to ensure release of individual seeds from the discharge location for sowing, wherein at least one of said resilient tines is positioned in at least one of a radially inner side and a radially outer side of said defined seed path.

2. The seed meter of claim 1, wherein said seed path is circular.

3. The seed meter of claim 1, wherein each of said resilient tines are radially spaced apart with respect to adjacent resilient tines on the radially inner side of said defined seed path.

4. The seed meter of claim 1, wherein each of said resilient tines are radially spaced apart with respect to adjacent resilient tines on the radially outer side of said defined seed path.

5. The seed meter of claim 1, wherein said resilient tines in an operative configuration are guided into each of said cavities to ensure presence of individual seed to be dispensed for sowing.

6. The seed meter of claim 1, wherein each of said resilient tines are deflected from said cavities by a plurality of structures defined on said seed metering device.

7. The seed meter of claim 1, wherein said resilient tines are made of Polyurethane, nylon or rubberized material.

8. The seed meter of claim 1, wherein said resilient tines are positioned about the fixed end for cantilevered motion.

9. The seed meter of claim 1, wherein said resilient tines provided on the outer side are provided with predefined clearances to facilitate movement of said resilient tines without interference.

10. The seed meter of claim 1, wherein at least a portion of said resilient tines are selectively adjustable by a sliding adjustable holder.

11. The seed meter of claim 1, wherein said resilient tines have a predefined profile, said predefined profile of said resilient tines is an arcuate profile, flat profile, cylindrical profile or polygonal profile.

12. The seed meter of claim 1, wherein said resilient tines have a predefined cross-section selected from the group consisting of circular, polygonal or oval.
